(19) United States
(12) Patent Application Publication
(10) Pub. No.: US 2013/0105406 A1
(43) Pub. Date: May 2, 2013

(54) EVAPORATIVE RECIRCULATION COOLING WATER SYSTEM, METHOD OF OPERATING AN EVAPORATIVE RECIRCULATION COOLING WATER SYSTEM

(71) Applicants: Albert Van Der Wal, Oegstgeest (NL); Hank Robert Reinhoudt, Delft (NL); Erik Driessen, Utrecht (NL)

(72) Inventors: Albert Van Der Wal, Oegstgeest (NL); Hank Robert Reinhoudt, Delft (NL); Erik Driessen, Utrecht (NL)

(73) Assignee: VOLTEA B.V., NL-2171 AE Sassenheim (NL)

(21) Appl. No.: 13/698,256

(22) PCT Filed: May 19, 2011
(86) PCT No.: PCT/EP11/58170

§ 371 Date: Jan. 7, 2013

(30) Foreign Application Priority Data
May 19, 2010 (EP) 10163269.3

(51) Int. Cl. C02F 9/00

(52) U.S. Cl. CPC C02F 9/00
USPC 210/748.16; 204/239; 210/177; 205/742; 205/743

(57) ABSTRACT

An evaporative recirculation cooling water system, the system having a recirculation loop to recirculate water through the system, a space to cool the water in the recirculation loop by evaporation, and an ion removal apparatus to remove ions. The ion removal apparatus has a flow through capacitor to remove hardness ions while leaving silica ions in the water. The flow through capacitor has an inlet connected to a water inlet and an outlet having a regulator to direct the flow of water to the recirculation loop or to a waste water output.

### FIELD

The present invention relates to, for example, an evaporative recirculation cooling system.

### BACKGROUND

In recent years one has become increasingly aware of the impact of human activities on the environment and the negative consequences this may have. Ways to reduce, reuse and recycle resources are becoming more important. In particular, clean water is becoming a scarce commodity.

An evaporative recirculation cooling water system may receive water from a water make-up stream. The water may be used in a recirculation loop and it may receive a heat load from, for example, a heat exchanger. The water may be cooled in an open space, e.g. a cooling tower, where the water comes in contact with air. The cooling may be enhanced by a partial evaporation of the water in the recirculation loop and this may cause water to be lost in the recirculation system which involves an intake of water from the make-up stream.

### SUMMARY

The evaporation and the addition of water from the make-up stream may cause an accumulation of dissolved species in the water of the recirculation loop. This accumulation of dissolved species may result in scaling in the recirculation system.

U.S. Pat. No. 4,532,045 discloses a chemical ion removal apparatus for removing ions from the make-up water to minimize the accumulation of dissolved species. For this purpose the apparatus is provided with an ion exchange system which includes weak acid cation exchange resin. A disadvantage of the use of the weak acid cation exchange resin may be the need for regeneration or replacement of the cation exchange resin.

Japanese patent application publication no. JP2002310595 discloses a cooling tower with a reverse osmosis membrane module which can separate cooling water into processed water from which ions are removed and concentrated water with ions. A disadvantage of the use of a membrane may be that it also removes silica ions which are a good corrosion inhibitor and another disadvantage may be that the membrane is sensitive to silica fouling and therefore an anti-foulant may be required.

European patent application publication no. EP1704123 discloses hardness ions being removed from source water in an aqueous cooling water system and control of specified chemistry residuals in the aqueous system to inhibit deposition of magnesium silicate and other silicate and silica scales on system surfaces, and to inhibit corrosion of system metallurgy. Hardness ions may be removed by ion exchange resin, reverse osmosis, electrochemical removal, chemical precipitation, or evaporation/distillation. A disadvantage however may be the removal of silicate which may be a good corrosion inhibiter. A further disadvantage may be that reverse osmosis may be sensitive to silicate scaling and that ion exchange resin requires regular regeneration by using chemicals.

It is an objective, for example, to improve the evaporative recirculation cooling water system.

Accordingly, there is provided an evaporative recirculation cooling water system, the system comprising:

a recirculation loop to recirculate water through the system;

a construction with a space to cool the water in the recirculation loop by evaporation;

an inlet to provide water into the recirculation loop; and

an ion removal apparatus to remove ions from the water, the ion removal apparatus comprising a flow through capacitor constructed and arranged to remove hardness ions from the water while leaving silica ions in the water.

The flow through capacitor may be selective for hardness ions while leaving silica ions in the water. Silica ions may be present in the form of dissolved, polymerized and/or monomeric silica. Water may be leaving the recirculation loop by evaporation which causes a build-up of silica ions in the recirculation loop. The latter may be advantageous because silica may be a good corrosion inhibitor. The addition of a corrosion inhibitor to the water may therefore be omitted or less corrosion inhibitor may be necessary.

The flow through capacitor may comprise a waste water outlet to discharge waste water with an increased concentration of hardness ions. The waste water will have the substantially same concentration of silica ions as the water that enters the flow through capacitor since the flow through capacitor does not substantially remove silica ions and hence does not alter the silica concentration.

The flow through capacitor may be between the inlet and the recirculation loop so as to remove hardness ions from the water of the inlet before the water is provided to the recirculation loop. Since the water from the inlet has a low concentration of silicate ions the waste water will have the same low concentration of silicate ions, leaving more silicate ions in the recirculation loop.

The flow through capacitor may be provided in a bypass of the recirculation loop so as to remove hardness ions from water in the recirculation loop. An advantage of the flow through capacitor in the bypass is that concentration of hardness ions in the recirculation loop can be directly controlled. The concentration of silicate ions in the waste water output of the flow through capacitor may however be higher resulting in lower accumulation of silica ions in the recirculation loop and some loss of silica.

The system may comprise a sensor configured to measure a chemical and/ or physical property of the water in the recirculation system. The sensor may measure one or more properties of the water in the recirculation system selected from: alkalinity, hardness, and/or conductance. The ion removal apparatus may comprise a flow adjuster, e.g. a pump, to adjust the velocity of the water flowing through the flow through capacitor. The system may include an addition device configured to provide a chemical additive to the water. The addition device is constructed and arranged to add a corrosion inhibitor, a scale inhibitor and/or a biocide to the water. The system may have a controller connected to the first and second electrodes of the flow through capacitor to control charging and/or discharging of the flow through capacitor; and connected to the regulator to direct water to the recirculation loop during charging of the flow through capacitor and to the waste water output during discharging of the flow through capacitor. The controller may be connected to the sensor and the flow adjuster so as to adjust the water velocity in the flow through capacitor in response to a function of the chemical and/or physical property of the water in the recirculation system.

In an embodiment, there is provided a method of operating an evaporative recirculation cooling water system, the method comprising:

recirculating water in a recirculation loop of the system;

cooling water in the recirculation loop by evaporation; and

removing hardness ions from the water while leaving silicate ions in the water by allowing the water to flow through a flow through capacitor while charging electrodes of the flow through capacitor and directing the water from the flow through capacitor to the recirculation loop after the hardness ions have been fully or partially removed from the electrodes.

The method may comprise removing hardness ions from the water before it enters the recirculation loop while leaving the silica ions, such as dissolved silica, monomeric silica and polymerized silica, in the water and concentrating silica ions in the recirculation loop by evaporation. Consequently, silica, such as polymerized and/or monomeric silica concentration, is increased in the cooling system and starts acting as a corrosion inhibitor, since the concentration reaches a concentration where silica acts as a corrosion inhibitor.

The concentration of silicate ions may become 3 to 5 times higher in the recirculation loop than in the entering the system. The silica ions may function as a good corrosion inhibitor at this concentration.

The method may further comprise directing the water from the flow through capacitor to a waste water output during discharging of the capacitor. The method may comprise providing a chemical additive to the water in the recirculation loop, the chemical additive being a corrosion inhibitor, a scale inhibitor, and/or a biocide. The chemical additive may be a non-ionic and/or non-charged chemical additive. The chemical additive may comprise one or more selected from the following rust inhibitors: polyphosphate, lignosulfonate, triazole, tannin, silicate, and/or sarcosinate. The chemical additive may comprise one or more selected from the following biocides: isothiazolin, bronopol, glutaraldehyde, diethyl-m-toluamide, hydrogen peroxide, and/or chlorine dioxide.

These and other aspects, features and advantages will become apparent to those of ordinary skill in the art from reading the following detailed description and the appended claims. For the avoidance of doubt, any feature of one aspect of the present invention may be utilized in any other aspect of the invention. It is noted that the examples given in the description below are intended to clarify the invention and are not intended to limit the invention to those examples per se. Similarly, all percentages are weight/weight percentages unless otherwise indicated. Numerical ranges expressed in the format “from x to y” are understood to include x and y. When for a specific feature multiple preferred ranges are described in the format “from x to y”, it is understood that all ranges combining the different endpoints are also contemplated.

### BRIEF DESCRIPTION OF THE FIGURES

Embodiments will be described, by way of example only, with reference to the accompanying schematic drawings in which corresponding reference symbols indicate corresponding parts, and in which:

FIG. 1 shows an evaporative recirculation cooling water system according to an embodiment; and

FIG. 2 shows an evaporative recirculation cooling water system according to a further embodiment.

### DETAILED DESCRIPTION

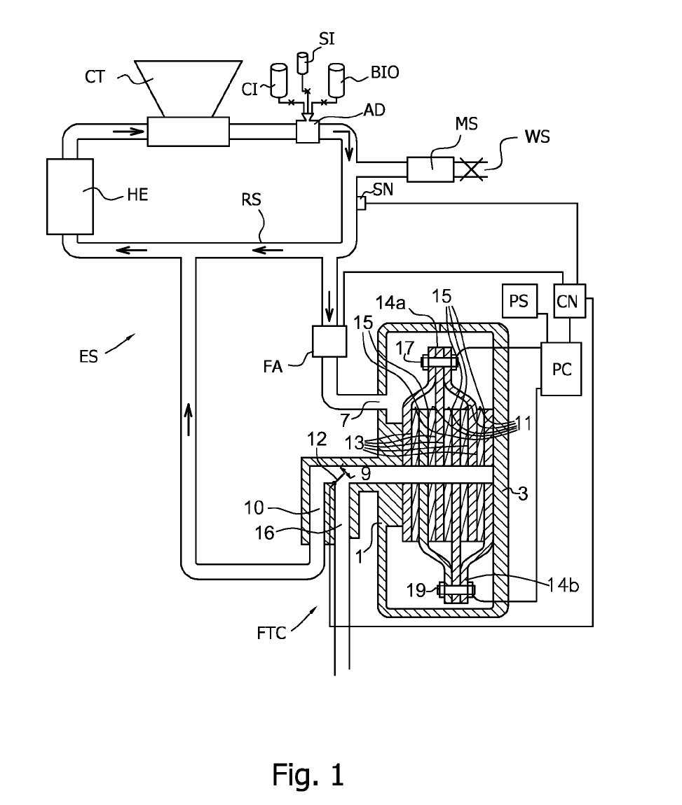

FIG. 1 shows an evaporative recirculation cooling water system ES according to an embodiment. The system comprises a water make-up stream MS to provide water to the recirculation loop RS from a water source WS, for example tap water. The recirculation loop RS may comprise a heat exchanger HE which warms the water and a cooling tower CT having a space to cool the water. An ion removal apparatus to remove ions comprising a flow through capacitor FTC is connected with the recirculation loop RS via an inlet 7 an outlet 9 having a regulator 12, e.g. valve, to direct the flow of water from the outlet 9 back to the recirculation circuit RS via purified water outlet 10 or to direct the flow of water to a waste water output 16.

The flow through capacitor has a housing comprising a first housing part 1 and a second housing part 3 made of a relatively hard material e.g. a hard plastic. By contacting the first and second housing parts to each other, for example with a bolt and nut (not shown,) the housing is made water tight.

The housing may have a water inlet 7 and a water outlet 9. During ion removal of the water, the water will flow from the inlet 7 to the outlet 9 through the spacers 11 which separates a first electrode 13 and a second electrode 15 of the flow through capacitor from each other. The current collectors 14a and 14b may be clamped within the housing and connected to power converter PC. By creating an electrical potential difference between the first and second electrodes by a power converter PC, for example by applying a positive voltage to the first electrode (the anode) 13 and a negative voltage to the second electrode (cathode) 15, the anions of the water flowing through the spacer 11 may be attracted to the first electrode and the cations may be attracted to the second electrode. In this way the ions (anions and cations) may be removed from the water flowing through the spacer 11. The purified water may be discharged to the purified water outlet 10 via the valve 12.

Once the electrodes are saturated with ions the electrodes may be regenerated, whereby the ions will be released in the water in the spacer 11 between the electrodes. The water in the spacer compartment with the increased ion content may be flushed away by closing the purified water outlet 10 with valve 12 under control of the controller CN and opening the waste water outlet 16. Once most ions are released from the electrodes and the water with increased ion content may be flushed away via the waste water outlet 16, the electrodes are regenerated and may be used again to attract ions.

A power converter PC under control of the controller CN may be used to convert the power from the power source PS to the right electrical potential. The electrical potential difference between the anode and the cathode is rather low, for example lower than 12 Volts, lower than 6 Volts, lower than 2 Volts or less than 1.5 Volts. The electrical resistance of the electrical circuit should be low. For this purpose, current collectors 14a which are in direct contact with the first electrodes are connected to each other with the first connector 17 and the current collectors 14b which are in direct contact with the second electrodes are connected to each other with the second connector 19. The current collectors 14a and 14b may be made substantially metal free to keep them corrosion free in the wet interior of the housing and at the same time cheap enough for mass production. The electrodes 13, 15 may be produced from a substantially metal free electrically conductive high surface area material, such as activated carbon, carbon black, carbon aerogel, carbon nanofiber, carbon nanotubes, graphene or a mixture thereof, placed on both sides of the current collector. The high surface area layer is a layer with a high surface area in square meters per weight of material, for example more than 500 square meters per gram of material. This set-up may ensure that the capacitor works as an electrical double layer capacitor with sufficient ion storage capacity. The overall surface area of even a thin layer of such a material is many times larger than a traditional material like aluminum or stainless steel, allowing many more charged species such as ions to be stored in the electrode material. The ion removal capacity of the apparatus is thereby increased.

A sensor SN configured to measure a chemical and/or physical property of the water in the recirculation system RS is included in the system. The sensor SN is configured to measure alkalinity, hardness, conductance and/or amount of the water in the recirculation system RS.

The ion removal apparatus may comprise a flow adjuster FA, for example, a pump, to adjust the velocity of the water flowing through the flow through capacitor FTC.

The evaporative recirculation cooling water system may comprise an addition device AD configured to provide a chemical additive to the water. The addition device AD may be connected to tank CI, BIO and/or SI to provide a corrosion inhibitor, a biocide and optionally a scale inhibitor, respectively, to the water. As depicted the addition device AD is configured to add a chemical to the water in the recirculation loop RS, however the chemical may in addition or alternatively be provided in the water make-up stream MS.

The controller CN may control a power converter PC which may be operably connected to the first electrodes 13 via the first connector 17 and the current collector 14a and with the second electrodes 15 via second connector 19 and the current collector 14b.

The controller CN controls charging and/or discharging of the flow through capacitor FTC and controls the valve 12 to direct water to the recirculation loop RS during charging of the flow through capacitor and to the waste water output 16 during discharging of the flow through capacitor. The controller CN may be connected to the sensor SN and the flow adjuster FA so as to adjust the water velocity in the flow through capacitor FTC in response to a function of the chemical and/or physical property of the water in the recirculation system RS. For example if the ion content of the water as measured with sensor SN is lower than a threshold value the flow adjuster FA may completely block the flow of water through the FTC and the FTC may not be operated. If the ion content in the recirculation loop RS will become higher than the threshold value as measured by the sensor SN the controller SN may switch the flow adjuster FA so as to pump water from the recirculation system through the FTC and the controller may control the power converter PC to charge the electrodes so as to remove ions from the water. The purified water will flow back to the recirculation system RS via the outlet 9 and the purified water outlet 10.

Once the electrodes of the flow through capacitor become saturated with ions the capacitor may be regenerated by going into a regeneration mode by reducing the applied potential or even reversing the polarity of the electrodes or by shunting the electrical circuit. The energy that is released during the regeneration mode can be recovered and returned to the power source PS. This may help to reduce the overall energy consumption of the apparatus. During regeneration the ions released from the electrodes will be released in the water in the flow through capacitor and are flushed away to the waste water output 16 via the valve 12. An advantage of the use of the evaporative recirculation cooling water system according to an embodiment of the invention is that less water is needed via the make-up water system MS because the concentration of dissolved species in the water of the recirculation loop can be kept lower with the flow through capacitor. Otherwise, water in the recirculation loop may be partially flushed to the waste water output to avoid a high concentration of dissolved species in the recirculation loop. With the flow through capacitor the dissolved species will be concentrated in the flow through capacitor and in a relatively high concentration flushed to the waste water output 16. The flow through capacitor according to an embodiment of the invention may selectively remove hardness ions while leaving silicate ions in the water. Water may be leaving the recirculation loop by evaporation which causes a build-up of silicate ions in the recirculation loop. The latter may be advantageous because silicate is a good corrosion inhibitor. The addition of a corrosion inhibitor to the water may therefore be omitted or less corrosion inhibitor may be required.

In an evaporative recirculation cooling water system, one or more chemicals may be added in order to avoid or minimize a common problem such as corrosion (rust), deposit formation (in the -warm- heat exchanger and cooling tower packing), and slime formation (due to excessive microbial growth). These chemicals are called a corrosion inhibitor, scale inhibitor and microbiocide respectively. By using the flow through capacitor less water will be drained from the recirculation cooling water system via the waste water output 16 and therefore less make-up water may be required resulting in a reduced chemical need for the recirculation cooling water system.

A corrosion inhibitor is a substance which, when added in small amount into a corrosive environment such as recirculating cooling water, reduces the rate of corrosion of the metal piping and heat exchanger present in the cooling system. A corrosion inhibitor may be classified as anodic, cathodic, or both, depending on which portion of the electrochemical corrosion cell it disrupts. Combining a cathodic with an anodic corrosion inhibitor provides synergy in corrosion inhibition.

A corrosion inhibitor that may be used in the evaporative recirculation cooling water system according to an embodiment of the invention includes a phosphate (orthophosphate, polyphosphate or a combination thereof), nitrite, zinc, lignosulfonate, molybdate, triazole (mercaptotriazole, benzotriazole, tolyltriazole), phosphonate (such as aminomethylenephosphonate, hydroxyethylene diphosphonate, phosphonobutanetricarboxylic acid, phosphonosuccinic acid), tannin, silicate (both ionic silica and colloidal or polymerized silica) and/or sarcosinate.

Because the FTC technology removes ionic species, and may not substantially remove a non-ionic or non-charged corrosion inhibitor, one or more of the following corrosion inhibitors may be advantageously used in a recirculating cooling system which has an FTC device on a bypass (constantly removing ionic salts from the recirculation water) according to an embodiment of the invention: polyphosphate, lignosulfonate, triazole, tannin, silicate and sarcosinate. Since the FTC will not substantially remove such a corrosion inhibitor, it is advantageous to use them in the evaporative recirculation cooling water system according to an embodiment of the invention. A silicate forms very weak ions in water which is not removed by the FTC at neutral pH. Since the FTC will not remove such a corrosion inhibitor it is advantageous to use it in the evaporative recirculation cooling water system according to an embodiment of the invention. At a higher pH value the silica may start to be removed by the FTC. Hence, by varying the pH of the feed water the level of silica, e.g. silicate, may be controlled in the cooling water system. Under normal operating conditions of the cooling water system it may be desirable to increase the silica level, such as dissolved silica and silicate, in the cooling water system. It is therefore desirable to operate the FTC such that the purified water may have a pH lower than 10, lower than 9 or lower than 8. On the other hand the pH of the purified water may not be too acidic in order to prevent acidic corrosion so the pH of the purified water may therefore be higher than 3, higher than 4 or higher than 5. A somewhat acidic pH of the purified water may be desired because then calcium carbonate scaling in the FTC and cooling water system do not occur, whereas at the same time silica deposits, such as silicate, are formed in the cooling water system, which may help to prevent corrosion. The pH of the water entering the FTC may therefore be measured (optionally with a pH sensor provided to the cooling tower system) and even adjusted by adding a base so that the pH of the water entering the FTC may be lower than 10, lower than 9 or lower than 8. The pH of the water entering the FTC may be measured (optionally with a pH sensor provided to the cooling tower system) and even adjusted by adding an acid so that the pH of the water entering the FTC may be larger than 3, larger than 4 or larger than 5.

A microbiocide is a substance which, when added in small amount to recirculating cooling water, reduces the rate of microbial growth in the cooling system, and avoids formation of biofouling (which may cause a secondary problem such as microbially induced corrosion (MIC) and which may negatively affect heat exchange efficiency both in a cooling tower and a heat exchanger). A microbiocide may be classified either as an oxidizing biocide or as a non-oxidizing biocide. Typically, a small amount of more expensive non-oxidizing biocide may be combined with a larger amount of less expensive oxidizing biocide. G proteins microbiocides inhibit microorganisms in a variety of ways. Some of these mechanisms are: altering permeability of the cell wall and/or cell membrane thereby interfering with vital processes of the microbe, destroying or denaturating essential proteins such as proteins involved in energy production of microbes, inhibition of enzyme-substrate reactions, oxidation of protein groups, etc.

A biocide that may be used in the evaporative recirculation cooling water system according to an embodiment of the invention includes a microbiocide such as: isothiazolin, bronopol, glutaraldehyde, diethyl-m-toluamide, hydrogen peroxide, chlorine dioxide, bromochlorodimethylhydantoin, bromide activated by bleach (either sodium bromide or ammonium bromide), quaternary ammonium salt, THPS (tetrakis(hydroxymethyl)phosphonium sulfate), sodium hypochlorite, peracetic acid, and/or DNPA (dibromonitrilopropionamide).

Because the FTC technology may remove ionic species, and may not substantially remove a non-ionic or non-charged microbiocide, one or more of the following microbiocides may be recommended for use in a recirculating cooling system which has an FTC device on a bypass (constantly removing ionic salts from the recirculation water) according to an embodiment: isothiazolin, bronopol, glutaraldehyde, diethyl-m-toluamide, hydrogen peroxide, and/or chlorine dioxide. Since the FTC may not substantially remove such a biocide it is advantageous to use it in an evaporative recirculation cooling water system according to an embodiment.

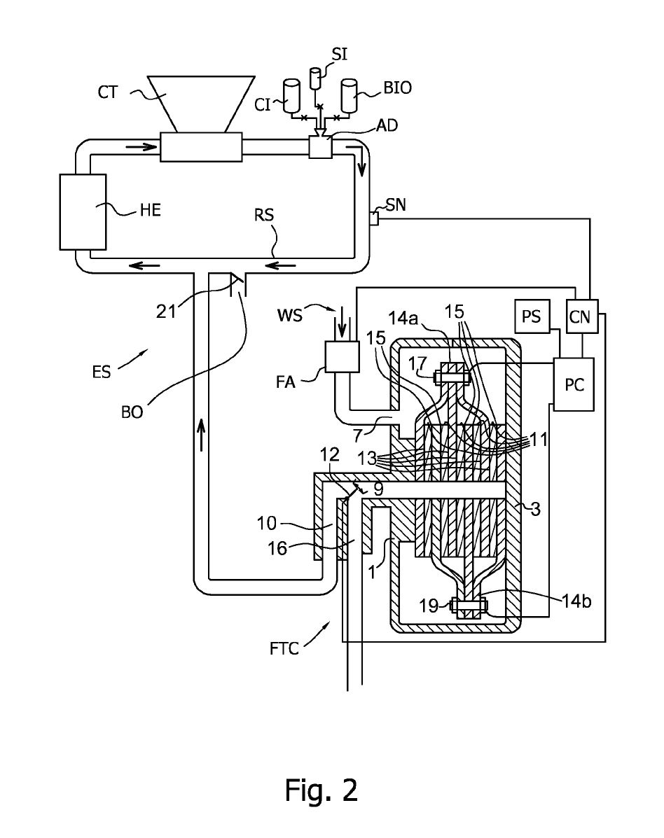

FIG. 2 shows an evaporative recirculation cooling water system ES according to a further embodiment. The system comprises a water source WS to provide water to the recirculation loop RS from, for example, tap water via a flow through capacitor FTC. The recirculation loop RS may comprise a heat exchanger HE which warms the water and a construction CT, e.g. a cooling tower, having a space to cool the water. An ion removal apparatus to remove ions e.g. a flow through capacitor FTC may be connected with the recirculation loop RS via a water outlet 9 having a regulator 12 e.g. valve to direct the flow of water from the water outlet 9 to the recirculation circuit RS via purified water outlet 10 or to direct the flow of water to a waste water output 16.

The flow through capacitor may have a housing comprising a first housing part 1 and a second housing part 3 made of a relatively hard material e.g. a hard plastic. By contacting the first and second housing parts to each other, for example with a bolt and nut (not shown) the housing is made water tight.

The housing may comprise a water inlet 7 and a water outlet 9. During ion removal of the water, the water will flow from the inlet 7 to the outlet 9 through the spacers 11 which separate a first electrode 13 and a second electrode 15 of the flow through capacitor from each other. The current collectors 14a and 14b are clamped within the housing and connected to a power converter PC. By creating an electrical potential difference between the first and second electrodes by a power converter PC, for example by applying a positive voltage to the first electrode (the anode) 13 and a negative voltage to the second electrode (cathode) 15 the anions of the water flowing through the spacer 11 are attracted to the first electrode and the cations are attracted to the second electrode. In this way ions (anions and cations) may be removed from the water flowing through the spacer 11. The purified water with reduced level of hardness ions may be discharged to the purified water outlet 10 via the valve 12.

Once the electrodes are saturated with ions the electrodes may be regenerated, whereby the ions will be released in the water in the spacer 11 in between the electrodes. The water in the spacer compartment with the increased ion content will be flushed away by closing the purified water outlet 10 with valve 12 under control of the controller CN and opening the waste water outlet 16. Once most ions are released from the electrodes and the water with increased ion content is flushed away via the waste water outlet 16 the electrodes are regenerated and can be used again for attracting ions.

A power converter PC under control of the controller CN is used to convert the power from the power source PS to the right electrical potential. The electrical potential differences between the anode and the cathode are rather low, for example lower than 12 Volts, lower than 6 Volts, lower than 2 Volts or less than 1.5 Volts. The electrical resistance of the electrical circuit should be low. For this purpose, current collectors 14a which are in direct contact with the first electrodes are connected to each other with the first connector 17 and the current collectors 14b which are in direct contact with the second electrodes are connected to each other with the second connector 19. The current collectors 14a and 14b may be made substantially metal free to keep them corrosion free in the wet interior of the housing and at the same time cheap enough for mass production. The electrodes 13, 15 may be produced from a substantially metal free electrically conductive high surface area material, such as activated carbon, carbon black, carbon aerogel, carbon nanofiber, carbon nanotube, graphene or a mixture thereof, placed on both sides of the current collector. The high surface area layer is a layer with a high surface area in square meters per weight of material, for example more than 500 square meters per gram of material. This set-up may ensure that the capacitor works as an electrical double layer capacitor with sufficient ion storage capacity. The overall surface area of even a thin layer of such a material is many times larger than a traditional material like aluminum or stainless steel, allowing many more charged species such as ions to be stored in the electrode material. The ion removal capacity of the apparatus is thereby increased.

A sensor SN to measure a chemical and/or physical property of the water in the recirculation system RS is included in the system. The sensor SN is configured to measure alkalinity, hardness, and/or conductance of the water in the recirculation system RS. The sensor SN may additionally or alternatively measure the amount of water in the recirculation loop.

The ion removal apparatus may comprise a flow adjuster FA, for example, a pump to adjust the velocity of the water flowing through the flow through capacitor FTC.

The evaporative recirculation cooling water system may comprise an addition device AD configured to provide a chemical additive to the water. The addition device AD may be connected to tanks CI, BIO and/or SI to provide a corrosion inhibitor, a biocide and optionally a scale inhibitor, respectively, to the water. As depicted the addition device AD is configured to add a chemical to the water in the recirculation loop RS, however the chemical may in addition or alternatively be provided in the water make-up stream MS after the FTC. By locating the flow through capacitor FTC between the water source WS and the addition device AD, the addition device AD may add the corrosion inhibitor CI, the biocide BIO and/or the scale inhibitor SI after the water has passed the FTC. The chemical additive will therefore not influence or harm the working of the FTC.

The controller CN may control a power converter PC which is operably connected to the first electrode 13 via the first connector 17 and the current collector 14a and with the second electrode 15 via current collector 14b and second connector 19.

The controller CN controls charging and/or discharging of the flow through capacitor FTC and controls the valve 12 to direct water to the recirculation loop RS during charging of the flow through capacitor and to the waste water output 16 during discharging of the flow through capacitor. The controller CN may be connected to the sensor SN and the flow adjuster FA so as to adjust the water velocity in the flow through capacitor FTC in response to a function of the chemical and/or physical property of the water in the recirculation system RS or the amount of water in the recirculation loop. For example if the amount of water as measured with sensor SN is lower than a threshold value the flow adjuster FA may increase the flow of water through the FTC and the FTC may be operated to remove the hardness ions from the water. The purified water will flow to the recirculation system RS via the outlet 9 and the purified water outlet 10.

Once the electrodes of the flow through capacitor become saturated with ions the capacitor may be regenerated by going in the regeneration mode by reducing the applied voltage or even reversing the polarity of the electrodes or by shunting the electrical circuit. The energy that is released during the regeneration mode can be recovered and returned to the power source PS. This may help to reduce the overall energy consumption of the apparatus for removal of ions. During regeneration the ions released from the electrodes will be released in the water in the flow through capacitor and are flushed away to the waste water output 16 via valve 12. An advantage of the use of the evaporative recirculation cooling water system according to an embodiment of the invention is that less water is needed via the make-up water system MS because the concentration of dissolved species in the water of the recirculation loop may be lower with the flow through capacitor.

In an evaporative recirculation cooling water system, one or more chemicals may be added in order to avoid or minimize a common problem such as corrosion (rust), deposit formation (in the -warm- heat exchanger and cooling tower packing), and/or slime formation (due to excessive microbial growth). These chemicals are called a corrosion inhibitor, scale inhibitor and microbiocide respectively. By using the flow through capacitor less water will be used from the make-up water system MS and flushed to the waste water output 16 so that less chemical may need to be added. The flow through capacitor according to an embodiment of the invention may selectively remove the hardness ions while leaving silica ions in the water. Water may be leaving the recirculation loop by evaporation which causes a build-up of silica ions in the recirculation loop. The concentration of silica ions may be 3 to 5 times higher in the recirculation loop caused by this build-up than in the water from the water source. The latter is advantageous because silica ions are a good corrosion inhibitor. The addition of a corrosion inhibitor to the water may therefore be omitted or less corrosion inhibitor may be necessary.

A corrosion inhibitor is a substance which, when added in small amount into a corrosive environment such as recirculating cooling water, reduces the rate of corrosion of the metal piping and heat exchanger present in the cooling system. A corrosion inhibitor may be classified as anodic, cathodic, or both, depending on which portion of the electrochemical corrosion cell it disrupts. Combining a cathodic with an anodic corrosion inhibitor provides synergy in corrosion inhibition.

A corrosion inhibitor that may be used in the evaporative recirculation cooling water system according to an embodiment of the invention includes a phosphate (orthophosphate, polyphosphate or a combination thereof), nitrite, zinc, lignosulfonate, molybdate, triazole (mercaptotriazole, benzotriazole, tolyltriazole), phosphonate (such as aminomethylenephosphonate, hydroxyethylene diphosphonate, phosphonobutanetricarboxylic acid, phosphonosuccinic acid), tannin, silicate (both ionic silica and colloidal or polymerized silica) and/or sarcosinate.

A microbiocide is a substance which, when added in small amount to recirculating cooling water, may reduce the rate of microbial growth in the cooling system, and avoids formation of biofouling (which may cause a secondary problem such as microbially induced corrosion (MIC) and which may negatively affect heat exchange efficiency both in a cooling tower and a heat exchanger). A microbiocide may be classified either as an oxidizing biocide or as a non-oxidizing biocide. Typically, a small amount of more expensive non-oxidizing biocide may be combined with a larger amount of less expensive oxidizing biocide. G proteins microbiocides inhibit microorganisms in a variety of ways. Some of these mechanisms are: altering permeability of the cell wall and/or cell membrane thereby interfering with vital processes of the microbe, destroying or denaturating essential proteins such as proteins involved in energy production of microbes, inhibition of enzyme-substrate reactions, oxidation of protein groups, etc.

A biocide that may be used in the evaporative recirculation cooling water system according to an embodiment of the invention includes a microbiocide such as: isothiazolin, bronopol, glutaraldehyde, diethyl-m-toluamide, hydrogen peroxide, chlorine dioxide, bromochlorodimethylhydantoin, bromide activated by bleach (either sodium bromide or ammonium bromide), quaternary ammonium salt, THPS (tetrakis(hydroxymethyl)phosphonium sulfate), sodium hypochlorite, peracetic acid, and/or DNPA (dibromonitrilopropionamide).

If the concentration of hardness ions in the water in the recirculation loop increases because of evaporation then the water may be drained via the blow down port BO. The sensor SN may be used to measure the concentration of hardness ions in the water of the recirculation loop and, via controller CN, the valve 21 to control the draining of the water may be opened if the concentration of hardness ions in the water is too high. The controller CN may control the flow adjuster FA to refresh the water in the recirculation loop with water having a low concentration of hardness ions because the majority of the hardness ions are removed by the FTC.

Embodiments are also provided in the following numbered clauses:

1. An evaporative recirculation cooling water system, the system comprising:

a water make-up input to provide water to the system;

a recirculation loop to recirculate water through the system;

a space to cool the water in the recirculation loop by evaporation; and

an ion removal apparatus configured to remove ions, the ion removal apparatus comprising a flow through capacitor having an inlet connected to the recirculation loop and an outlet having a regulator to direct the flow of water from the outlet back to the recirculation loop or to direct the flow of water to a waste water output.

2. The system according to clause 1, wherein the flow through capacitor comprises a first and second electrode and a spacer to separate the first and second electrodes and to allow water to flow in between the first and second electrodes.
3. The system according to clause 1 or clause 2, further comprising a sensor configured to measure a chemical and/or physical property of the water in the recirculation system.
4. The system according to clause 3, wherein the sensor is configured to measure one or more properties of the water in the recirculation system selected from: alkalinity, hardness, and/or conductance.
5. The system according to any of clauses 1-4, further comprising a flow adjuster configured to adjust the velocity of the water flowing through the flow through capacitor.
6. The system according to any of clauses 1-5, further comprising an addition device configured to provide a chemical additive to the water.
7. The system according to clause 6, wherein the addition device is constructed and arranged to add a corrosion inhibitor, a scale inhibitor and/or a biocide to the water.
8. The system according to any of clauses 1-7, further comprising a controller configured to control charging and/or discharging of first and second electrodes of the flow through capacitor, and to control the regulator to direct water to the recirculation loop during charging of the flow through capacitor and to the waste water output during discharging of the flow through capacitor.
9. The system according to clause 8, wherein the controller is further configured to control a flow adjuster so as to adjust the water velocity in the flow through capacitor in response to a function of a chemical and/or physical property of the water in the recirculation system as measured with a sensor.
10. A method of operating an evaporative recirculation cooling water system, the method comprising:

allowing water to enter a recirculation loop of the system via a water make-up inlet;

recirculating water in the recirculation loop;

cooling water in the recirculation loop by evaporation; and

removing ions from the water in the recirculation loop by allowing the water to flow through a flow through capacitor while charging the flow through capacitor and directing the water from the flow through capacitor back to the recirculation loop.

11. The method according to clause 10, further comprising directing water from the flow through capacitor to a waste water output during discharging of the capacitor.
12. The method according to clause 10 or clause 11, further comprising providing a chemical additive to the water in the recirculation loop, the chemical additive being one or more selected from: a corrosion inhibitor, a scale inhibitor, and/or a biocide.
13. The method according to clause 12, wherein the chemical additive is a non-ionic and/or non-charged chemical additive.
14. The method according to clause 12 or clause 13, wherein the chemical additive comprises one or more selected from the following rust inhibitors: polyphosphate, lignosulfonate, triazole, tannin, silicate, and/or sarcosinate.
15. The method according to clause 12 or clause 13, wherein the chemical additive comprises one or more selected from the following biocides: isothiazolin, bronopol, glutaraldehyde, diethyl-m-toluamide, hydrogen peroxide, and/or chlorine dioxide.

While specific embodiments have been described above, it will be appreciated that the invention may be practiced otherwise than as described. The description is intended to be illustrative, not limiting. Thus, it will be apparent to one skilled in the art that modifications may be made without departing from the scope of the claims set out below.

1. An evaporative recirculation cooling water system, the system comprising:
a recirculation loop to recirculate water through the system;
a construction with a space to cool the water in the recirculation loop by evaporation;
an input to provide water into the recirculation loop; and
an ion removal apparatus to remove ions from the water, the ion removal apparatus comprising a flow through capacitor constructed and arranged to remove hardness ions from the water while leaving silica ions in the water.

2. The system according to claim 1, wherein the flow through capacitor comprises a waste water output to discharge waste water with an increased concentration of hardness ions.

3. The system according to claim 1, wherein the flow through capacitor is between the input and the recirculation loop so as to remove hardness ions from the water of the input before the water from the input is provided to the recirculation loop.

4. The system according to claim 1, wherein the flow through capacitor is in a bypass of the recirculation loop so as to remove hardness ions from water in the recirculation loop.

5. The system according to claim 1, further comprising a sensor to measure a chemical and/or physical property of the water in the recirculation loop.

6. The system according to claim 1, wherein the ion removal apparatus comprises a flow adjuster to adjust a velocity of the water flowing through the flow through capacitor.

7. The system according to claim 1, further comprising an addition device configured to provide a chemical additive to the water and the addition device is constructed and arranged to add a corrosion inhibitor, a scale inhibitor and/or a biocide to the water.

8. The system according to claim 1, further comprising a controller configured to: control charging and/or discharging of a first and second electrode of the flow through capacitor; and control a regulator to direct water to the recirculation loop during charging of the flow through capacitor and to the waste water output during discharging of the flow through capacitor, wherein the controller is further configured to control a flow adjuster so as to adjust the water velocity in the flow through capacitor in response to a function of a chemical and/or physical property of the water in the recirculation system as measured with a sensor.

9. The system, according to claim 1, wherein the concentration of silica ions in the recirculation loop is controlled by control of the pH of water entering the flow through capacitor to a pH value between 3 and 10.

10. A method of operating an evaporative recirculation cooling water system, the method comprising:
recirculating water in a recirculation loop of the system;
cooling water in the recirculation loop by evaporation; and
removing hardness ions from the water while leaving the silica ions in the water by allowing the water to flow through a flow through capacitor while charging the flow through capacitor and directing the water from the flow through capacitor to the recirculation loop after the hardness ions have been removed.

11. The method according to claim 10, comprising removing hardness ions from the water before the water enters the recirculation loop while leaving the silica ions in the water and concentrating those silica ions in the recirculation loop by evaporation.

12. The method according to claim 10, wherein the concentration of silica ions is between 3 to 5 times higher in the recirculation loop than in the water entering the recirculation loop.

13. The method according to claim 10, wherein the concentration of silica ions in the recirculation loop is controlled by controlling the pH of water entering the flow through capacitor.

14. The method according to claim 10, further comprising controlling the pH of water entering the flow through capacitor to a pH value between 3 and 10.

15. The method according to claim 10, further comprising adding a chemical additive to the water wherein the chemical additive is a non-ionic and/or non-charged chemical additive.

16. The method according to claim 15, wherein the chemical additive comprises one or more selected from the following rust inhibitors: polyphosphate, lignosulfonate, triazole, tannin, silicate, and/or sarcosinate.

17. The method according to claim 15, wherein the chemical additive comprises one or more selected from the following biocides: isothiazolin, bronopol, glutaraldehyde, diethyl-m-toluamide, hydrogen peroxide, and/or chlorine dioxide.

18. The method according to claim 10, comprising directing water from the recirculation loop to the flow through capacitor to remove hardness ions from water of the recirculation loop while leaving the dissolved silica ions in the water and returning the water to the recirculation loop.
